(19) United States
(12) Patent Application Publication
(10) Pub. No.: US 2020/0387156 A1
(43) Pub. Date: Dec. 10, 2020

(54) Autonomous Coach Vehicle Learned From Human Coach

(71) Applicant: DENSO International America, Inc., Southfield, MI (US)

(72) Inventors: Yunfei XU, Milpitas, CA (US); Takashi BANDO, Mountain View, CA (US)

(21) Appl. No.: 16/433,677

(22) Filed: Jun. 6, 2019

(51) Int. Cl. G05D 1/00; G05D 1/02; B60W 10/18; B60W 10/20; B60W 10/04; B60W 30/18; B60Q 9/00; G05B 13/02

(52) U.S. Cl. CPC G05D 1/0061; B60W 2710/0605; G05D 1/0212; B60W 10/18; B60W 10/20; B60W 10/04; B60W 30/18; B60Q 9/00; G05B 13/0265; G05D 2201/0213; B60W 2420/52; B60W 2420/42; B60W 2420/54; B60W 2520/105; B60W 2550/406; B60W 2710/18; B60W 2710/20; G05D 1/0088

(57) ABSTRACT

Systems and methods of the present disclosure include a motion planning module that iteratively determines possible trajectories for a vehicle to follow, calculates an estimated cost associated with each possible trajectory based on cost functions and cost weights, each cost function corresponding to a trajectory evaluation feature, and selects an optimal trajectory having a least associated estimated cost. When the vehicle is operated in a learning mode, a learning module determines a first actual trajectory traveled by the vehicle, compares the first actual trajectory with the optimal trajectory for that time period, and updates the cost weights based on the comparison. When the vehicle is operated in a teaching mode, a teaching module determines a second actual trajectory traveled by the vehicle, compares the second actual trajectory with the optimal trajectory selected for that time period, and generates output to a user of the vehicle based on the comparison.

### FIELD

The present disclosure relates to systems and methods for an autonomous coach vehicle for driving instruction, including an autonomous coach vehicle that learns from human coach drivers.

### BACKGROUND

This section provides background information related to the present disclosure which is not necessarily prior art.

Traditionally, new vehicle drivers, or student drivers, are trained to drive by driving with a human coach in the passenger seat. The human coach, for example, can monitor the operation of the vehicle by the student driver and provide instruction and feedback to the student driver as the student driver is driving and operating the vehicle. This process requires a human coach to be in the vehicle with the student driver to provide the instruction and feedback. Also, the results can vary from human coach to human coach and from student driver to student driver.

### SUMMARY

This section provides a general summary of the disclosure, and is not a comprehensive disclosure of its full scope or all of its features.

The present disclosure includes a system comprising a motion planning module configured to iteratively determine a plurality of possible trajectories for a vehicle to follow, calculate an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature, and select an optimal trajectory from the plurality of possible trajectories for each of a plurality of time periods, the optimal trajectory having a least associated estimated cost out of the plurality of possible trajectories. The system also includes a learning module configured to, when the vehicle is operated in a learning mode during a first time period of the plurality of time periods, determine a first actual trajectory being traveled by the vehicle during the first time period, compare the first actual trajectory with the optimal trajectory selected by the motion planning module during the first time period, and update the plurality of cost weights based on the comparison. The system also includes a teaching module configured to, when the vehicle is operated in a teaching mode during a second time period of the plurality of time periods, determine a second actual trajectory being traveled by the vehicle during the second time period, compare the second actual trajectory with the optimal trajectory selected by the motion planning module during the second time period, and generate output to a user of the vehicle based on the comparison.

The present also includes a method that includes determining, with a motion planning module, a plurality of possible trajectories for a vehicle to follow. The method also includes calculating, with the motion planning module, an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature. The method also includes selecting, with the motion planning module, an optimal trajectory from the plurality of possible trajectories for each of a plurality of time periods, the optimal trajectory having a least associated estimated cost out of the plurality of possible trajectories. The method also includes determining, with a learning module and when the vehicle is operated in a learning mode during a first time period of the plurality of time periods, a first actual trajectory being traveled by the vehicle during the first time period. The method also includes comparing, with the learning module, the first actual trajectory with the optimal trajectory selected by the motion planning module during the first time period. The method also includes updating, with the learning module, the plurality of cost weights based on the comparison. The method also includes determining, with a teaching module and when the vehicle is operated in a teaching mode during a second time period of the plurality of time periods, a second actual trajectory being traveled by the vehicle during the second time period. The method also includes comparing, with the teaching module, the second actual trajectory with the optimal trajectory selected by the motion planning module during the second time period. The method also includes generating, with the teaching module, output to a user of the vehicle based on the comparison.

The present disclosure also includes an autonomous coach vehicle that includes at least one vehicle sensor including at least one of a vehicle speed sensor, a vehicle acceleration sensor, an image sensor, a Lidar sensor, a radar sensor, a stereo sensor, an ultrasonic sensor, a global positioning system, and an inertial measurement unit. The autonomous coach vehicle also includes a perception module configured to generate object information about objects in a surrounding environment of the autonomous coach vehicle based on data from the at least one vehicle sensor. The autonomous coach vehicle also includes a prediction module configured to generate obstacle information based on the object information from the perception module. The autonomous coach vehicle also includes a motion planning module configured to iteratively determine a plurality of possible trajectories for the autonomous coach vehicle to follow based on the object information from the perception module and the obstacle information from the prediction module, calculate an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature, and select an optimal trajectory from the plurality of possible trajectories for each of a plurality of time periods, the optimal trajectory having a least associated estimated cost out of the plurality of possible trajectories. The autonomous coach vehicle also includes a learning module configured to, when the autonomous coach vehicle is operated in a learning mode during a first time period of the plurality of time periods, determine a first actual trajectory being traveled by the autonomous coach vehicle during the first time period, compare the first actual trajectory with the optimal trajectory selected by the motion planning module during the first time period, and update the plurality of cost weights based on the comparison. The autonomous coach vehicle also includes a teaching module configured to, when the autonomous coach vehicle is operated in a teaching mode during a second time period of the plurality of time periods, determine a second actual trajectory being traveled by the autonomous coach vehicle during the second time period, compare the second actual trajectory with the optimal trajectory selected by the motion planning module during the second time period, and generate output to a user of the autonomous coach vehicle when a difference between the second actual trajectory and the optimal trajectory is greater than a predetermined threshold, the generated output providing instructions to the user indicating at least one action for the user to perform to control the autonomous coach vehicle during a third time period of the plurality of time periods so a third actual trajectory traveled by the autonomous coach vehicle during the third time period will correspond to the optimal trajectory selected by the motion planning module during the third time period.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an autonomous coach vehicle according to the present teachings.

FIG. 2 illustrates a block diagram including certain components of the autonomous coach vehicle according to the present teachings.

FIG. 3 illustrates a block diagram including certain components of, and information used by, the autonomous coach vehicle according to the present teachings.

FIG. 4 illustrates a combination block diagram and flow diagram for a motion planning module of the autonomous coach vehicle according to the present teachings.

FIG. 5 illustrates a combination block diagram and flow diagram for a system and method of teaching a novice driver with an autonomous coach vehicle according to the present teachings.

FIG. 6 illustrates a flow diagram for a method of fine tuning cost weights for an autonomous coach vehicle according to the present teachings.

FIG. 7 illustrates a flow diagram for a method of performance evaluation of an autonomous coach vehicle according to the present teachings.

FIG. 8 illustrates a flow diagram for a method of teaching a novice driver with an autonomous coach vehicle according to the present teachings.

FIG. 9 illustrates a flow diagram for a method of emergency situation monitoring with an autonomous coach vehicle according to the present teachings.

Corresponding reference numerals indicate corresponding parts throughout the several views of the drawings.

### DETAILED DESCRIPTION

Example embodiments will now be described more fully with reference to the accompanying drawings.

The present teachings include an autonomous coach vehicle that is trained by an expert driver. For example, the autonomous coach vehicle can be driven in a manual mode by an expert driver while the autonomous coach vehicle monitors the expert driver's operation and control of the vehicle's actuation systems, such as the steering, throttle, and braking systems of the autonomous coach vehicle. The autonomous coach vehicle can determine the resulting corresponding actual trajectories traveled by the autonomous coach vehicle based on the expert driver's operation of the vehicle's actuation systems. The autonomous coach vehicle can also determine the calculated trajectories that the vehicle would have selected based on input from the various sensors of the autonomous vehicle and compare the calculated trajectories of the autonomous vehicle with the actual trajectories determined based on the expert driver's operation of the autonomous vehicle. Based on the comparison, the autonomous vehicle can then fine tune parameters used by the vehicle to select trajectories, such as the cost function weights used to select trajectories, so that the behavior of the autonomous coach vehicle more closely mimics the behavior of the vehicle when it is driven by the expert driver. In this way, the expert driver can train the autonomous coach vehicle. Once trained, the autonomous coach vehicle selects trajectories that are more similar to the driving of the expert driver, as compared with those of the autonomous coach vehicle prior to training.

Once trained, the autonomous coach vehicle can be used to train a novice driver, such as a student driver. For example, the novice driver can drive the autonomous coach vehicle in the manual mode while the autonomous coach vehicle monitors the novice driver's operation and control of vehicle's actuation systems, such as the steering, throttle, and braking systems of the autonomous coach vehicle. The autonomous coach vehicle can determine the resulting corresponding actual trajectories traveled by autonomous coach vehicle based on the novice driver's operation of the vehicle's actuation systems. The autonomous coach vehicle can also determine the calculated trajectories that the vehicle would have selected based on input from the various sensors of the autonomous vehicle and compare the calculated trajectories of the autonomous vehicle with the actual trajectories being driven by vehicle based on the novice driver's operation and control of the autonomous coach vehicle.

Based on the comparison, the autonomous coach vehicle can provide visual, audio, or haptic feedback to the novice driver. For example, when the actual trajectories of the vehicle deviate more than a predetermined amount from the calculated trajectories, the autonomous coach vehicle can provide visual, audio, or haptic feedback to alert the novice driver to make adjustments to the novice driver's driving behavior. For example, if the novice driver is driving the vehicle too close to an edge of the road or too close to another vehicle traveling ahead of the autonomous coach vehicle, the autonomous coach vehicle can issue visual, audio, or haptic feedback to instruct the novice driver to move the vehicle away from the edge of road, to move the vehicle closer to the center of the road, and/or to slow down to allow a greater distance to the vehicle traveling ahead of the autonomous coach vehicle. In other words, the autonomous coach vehicle provides feedback and instruction to the novice driver so that the novice driver's driving behavior more closely mimics the driving behavior that would be exhibited if the autonomous coach vehicle were being driving in an autonomous mode.

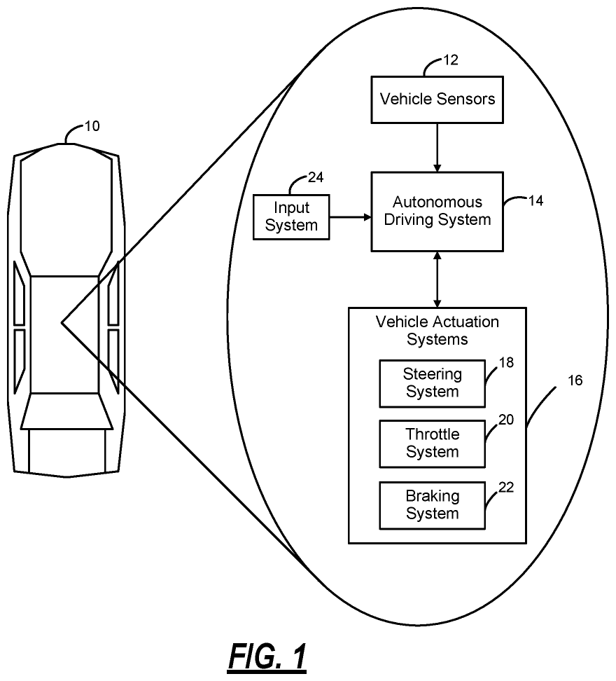

With reference to FIG. 1, an autonomous coach vehicle 10 is illustrated. The autonomous coach vehicle may also be referred to interchangeably as an autonomous vehicle, a self-driving vehicle, a subject vehicle, or a vehicle. Although the self-driving vehicle 10 is illustrated as an automobile in FIG. 1, the present teachings apply to any other suitable vehicle, such as, for example, a sport utility vehicle (SUV), a mass transit vehicle (such as a bus), etc. The autonomous coach vehicle 10 includes vehicle sensors 12 that provide input to an autonomous driving system 14.

The vehicle sensors 12 can include a global positioning system (GPS) that determines location data indicating a location of the vehicle 10. Additionally or alternatively, the vehicle sensors 12 can include a GPS and inertial measurement unit (GPS/IMU) that determines location and inertial/orientation data of the vehicle 10. The vehicle sensors 12 can also include a vehicle speed sensor that generates data indicating a current speed of the vehicle 10 and a vehicle acceleration sensor that generates data indicating a current rate of acceleration or deceleration of the vehicle 10.

The vehicle sensors 12 can also include a number of environmental sensors to sense information about the surroundings of the vehicle 10. For example, the vehicle sensors 12 can include an image sensor, such as a camera, mounted to, for example, a roof of the vehicle 10. The vehicle 10 can also be equipped with additional image sensors at other locations on or around the vehicle 10, such as a front bumper, a rear bumper, a side door, a side-view mirror, etc. Additionally, the vehicle 10 can be equipped with one or more front sensors located near a front bumper of the vehicle 10, one or more side sensors located on side-view mirrors or side doors of the vehicle 10, and/or one or more rear sensors located on a rear bumper of the vehicle 10. The front sensors, side sensors, and rear sensors can be, for example, image sensors (i.e., cameras), Lidar sensors, stereo sensors, radar sensors, ultrasonic sensors, or other sensors for detecting information about the surroundings of the vehicle 10, including, for example, other vehicles, lane lines, guard rails, objects in the roadway, buildings, pedestrians, etc.,

Additional environmental sensors can be located on or around the vehicle 10. The vehicle sensors 12 can also include sensors to determine a light level of the environment of the vehicle 10, e.g., whether it is daytime or nighttime, to determine or receive weather data, e.g., whether it is a sunny day, raining, cloudy, etc., to determine the current temperature, to determine the road surface status, e.g., dry, wet, frozen, number of lanes, types of lane marks, concrete surface, asphalt surface, etc., to determine traffic conditions for the current path or route of the vehicle 10, and/or other applicable environmental information.

The vehicle sensors 12 output the sensed data and information to the autonomous driving system 14. As described in further detail below, the autonomous driving system 14 can receive the sensed data and information from the vehicle sensors 12, access other data, such as map data, about the environment and location of the vehicle 10, and determine a current trajectory to be driven by the vehicle 10 based on the sensed data and information. When operated in an autonomous mode, the autonomous driving system 14 controls vehicle actuation systems to operate and drive the vehicle 10 based on the determined current trajectory. The autonomous driving system 14 iteratively and continually receives the sensed data and information from the vehicle sensors 12 and iteratively and continually updates the current trajectory and/or determines a new trajectory for the vehicle 10.

The autonomous driving system 14 controls the vehicle actuation systems 16 to operate and drive the vehicle 10 to follow the determined current trajectory. For example, the vehicle actuation systems 16 include a steering system 18 for steering the vehicle 10, a throttle system 20 for accelerating and propelling the vehicle 10, and a braking system 22 for decelerating and stopping the self-driving vehicle 10.

The vehicle 10 also includes an input system 24 that receives user input from a user of the vehicle. For example, the input system 24 can include an input device such as keyboard or a touchscreen that receives destination input from the user indicating a destination that the user would like to travel to. Additionally or alternatively, the input system 24 can include a microphone and a speech recognition system that receives audio input spoken by the user as the destination input indicating the destination that the user would like to travel to. Additionally or alternatively, the input system can include or be a part of a navigation or infotainment system of the vehicle 10. In addition, any other suitable input system that receives destination input from a user indicating a destination that the user would like to travel to can be used in accordance with the present teachings.

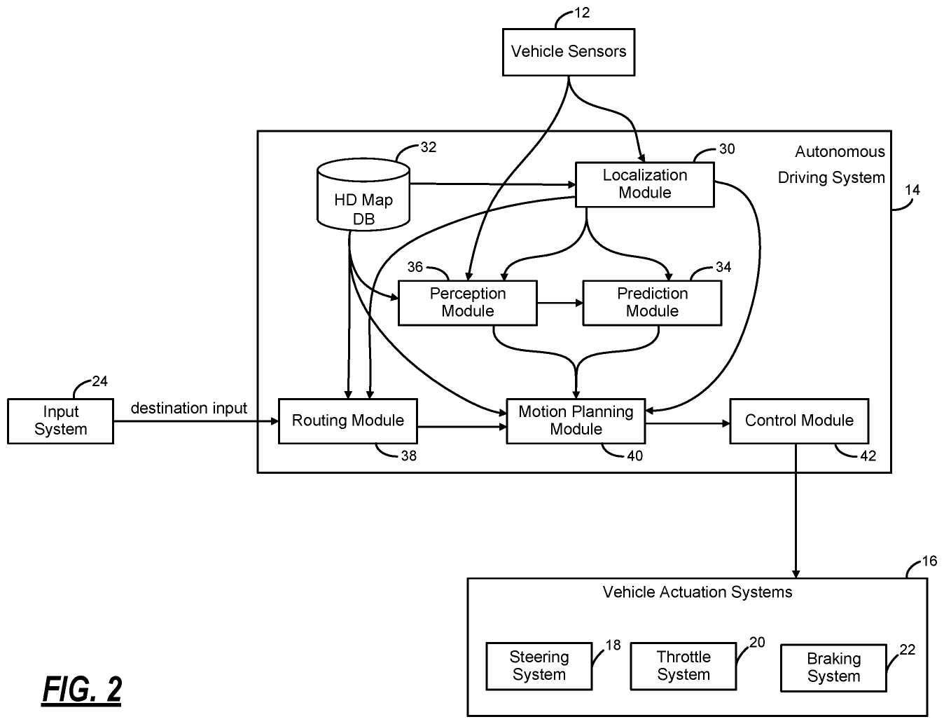

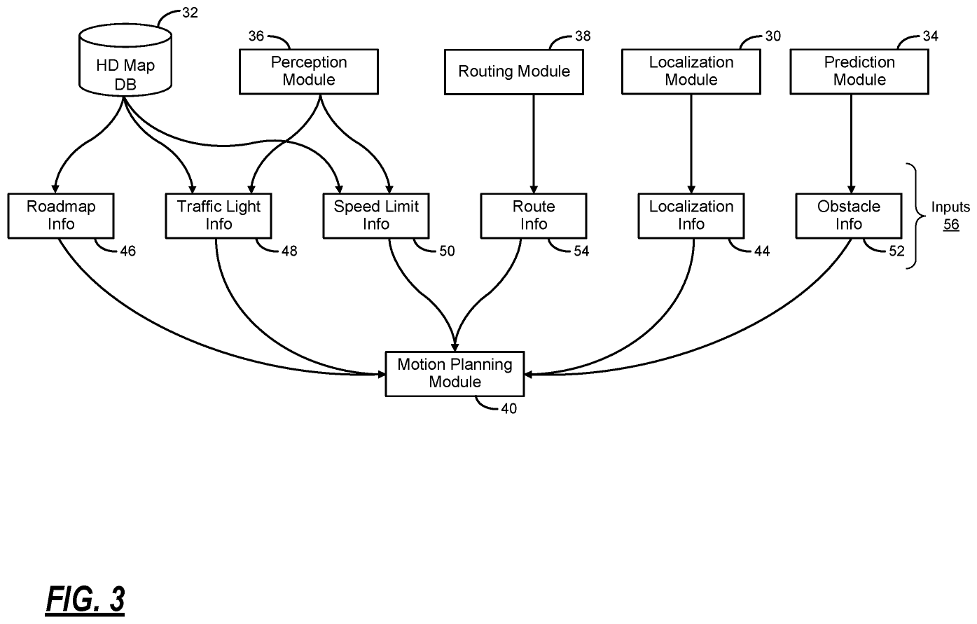

With reference to FIGS. 2 and 3, the autonomous driving system 14 includes a localization module 30, a high definition (HD) map database (DB) 32, a prediction module 34, a perception module 36, a routing module 38, a motion planning module 40, and a control module 42. The motion planning module 40 receives information from the localization module 30, the HD Map DB 32, the prediction module 34, the perception module 36, and the routing module 38, and determines a trajectory for the vehicle 10 to follow over a predetermined time period. The predetermined time period may be, for example, five to ten seconds, although any other predetermined time period can be used. The trajectory includes a selected waypoints for the vehicle to follow. In other words, the trajectory can consist of a sequence of waypoints for the vehicle to follow or traverse over the predetermined time period. For example, the trajectory can correspond to continuing forward in the current lane of travel. In such case, the trajectory would include a set of waypoints for the vehicle 10 to follow to continue forward in the current lane. In the event the current lane includes a curve, the waypoints would include waypoints along the current lane accounting for the curve of the lane. As another example, the trajectory can correspond to changing lanes to the left. In such case, the trajectory would include a set of waypoints for the vehicle 10 to follow to perform changing lanes to the left.

The motion planning module 40 outputs the current trajectory to the control module 42. The control module 42 receives the current trajectory from the motion planning module 40 and appropriately controls the vehicle actuation systems 16, i.e., the steering system, the throttle system 20, and the braking system 22, to follow the current trajectory with the vehicle 10. For example, if the current trajectory includes waypoints for changing lanes to the left, the control module 42 appropriately controls the vehicle actuation systems 16 so the vehicle 10 follows the waypoints and changes lanes to the left.

The localization module 30 receives sensed information from the vehicle sensors 12 and roadmap information 46 from the HD map DB 32 and outputs localization information 44 to the motion planning module 40, the prediction module 34, and the perception module 36. The localization information can include, for example, a GPS location of the vehicle 10 along with an exact orientation, position, and specific location within an environment of the vehicle. For example, the vehicle sensors 12 may include a GPS/IMU that can determine a location of the vehicle 10, but may not provide sufficient specificity to determine the exact orientation, position, and specific location of the vehicle 10 at that GPS location. The localization module 30 can utilize additional environmental information from the vehicle sensors 12 to determine localization information, such as the exact orientation, position, and specific location of the vehicle 10, within the environment of the vehicle 10 at the indicated GPS location. For example, the localization module 30 can use information from the cameras, Lidar sensors, stereo sensors, radar sensors, ultrasonic sensors, other sensors, etc., to sense information about the environment of the vehicle 10, compare the sensed information with known information about the environment from the HD map DB 32, and then determine the exact orientation, position, and specific location of the vehicle 10 at that GPS location based on the comparison.

The perception module 36 receives sensed information about the surroundings of the vehicle 10 and determines and/or identifies objects, such as obstacles, that are sensed by the vehicle sensors and located in the surrounding environment of the vehicle 10. For example, the perception module generates object information about objects within the surroundings of the vehicle 10 and sensed by the vehicle sensors 12. For example, the perception module 36 can receive information about the surroundings of the vehicle from the cameras, Lidar sensors, stereo sensors, radar sensors, ultrasonic sensors, other sensors, etc. Based on the information from the vehicle sensors 12, the perception module 36 can identify objects and obstacles in the surroundings of the vehicle 10, such as other vehicles, bicyclists, pedestrians, guardrails, embankments, road shoulders, speed bumps, etc. The perception module 36 can also receive localization information 44 from the localization module and roadmap information 46 from the HD map DB 32. The perception module 36 can use the localization information and roadmap information 46 to assist in determining and/or identifying objects located within the surrounding environment of the vehicle 10. For example, the perception module 36 can identify traffic lights and generate traffic light information 48, including a current color or status of a traffic light. The perception module 36 can also identify speed limit signs and generate speed limit information 50, including a current speed limit of the road being traveled by the vehicle 10. Additionally or alternatively, the traffic light information 48 and the speed limit information 50 can be stored in and retrieved from the HD map DB 32 and/or with the assistance of the HD map DB 32. For example, the perception module 36 may use information from the HD map DB 32 to determine that a traffic light should be located at an upcoming intersection. The perception module 36 can then utilize information from the cameras of the vehicle sensors 12 to locate the traffic light, determine a current status of the traffic light, and generate the traffic light information 48 that is then outputted to the motion planning module 40.

The prediction module 34 receives localization information 44 from the localization module 30 and information about determined and identified objects located in the surrounding environment of the vehicle 10 from the perception module 36. Based on the received information from the localization module 30 and the perception module 36, the prediction module 34 determines and predicts obstacle information 52 about potential obstacles in the surrounding environment of the vehicle 10, including, for example, the predicted trajectories of obstacles in the surrounding environment of the vehicle. For example, the prediction module 34 may receive information from the perception module 36 indicating that an object, such as another vehicle, a pedestrian, or an animal, exists laterally to the side of the vehicle 10. Based on information from the perception module 36 over time and localization information 44 from the localization module 30 over time, the prediction module 34 may determine a current trajectory of the object. The current trajectory of the object may intersect with a possible trajectory of the vehicle 10. The prediction module 34 outputs the obstacle information 52 to the motion planning module 40. The planning motion planning module 40 can then receive the obstacle information 52 and check for possible collisions with the object in each of multiple plan candidates, or trajectories, for the vehicle 10.

The routing module 38 receives destination input indicating a destination location for the vehicle 10. The destination input can be received via voice or text input from an operator of the self-driving vehicle 10 or can be received remotely from a remote computing device. The routing module 38 can receive traffic information data from the vehicle sensors 12, such as from a GPS or other communication system. The traffic information data may include data indicating traffic conditions in the geographic area of the vehicle 10 and indicating traffic conditions along one or more routes from the current location of the vehicle 10 to the inputted destination. Additionally or alternatively, if the self-driving vehicle 10 includes a communication system, such as a V2X communication system, the routing module 38 can receive the traffic information data from the V2X system based on communication with other vehicles, a cloud computing device, and/or infrastructure locations that are also equipped with a V2X system. The routing module 38 also receives map data about the surroundings of the self-driving vehicle 10 and about various possible routes from the current location of the self-driving vehicle to the inputted destination from the HD map DB 32. Additionally or alternatively, the routing module 38 can receive the map data from a remote computing device in communication with the vehicle. The planning module 38 can receive localization information 44 from the localization module 30. The localization information 44 can include, for example, a current position of the vehicle 10 within the surrounding environment, as well as a direction, a velocity, and/or an acceleration or deceleration in the current direction. The routing module 38 can determine a route to the inputted destination based on the current location of the vehicle 10 as indicated by the localization information 44, based on the map data from the HD map DB 32, and based on the traffic information data. The routing module 38, for example, can use conventional route planning to determine and output the route to the inputted destination, including a series of route segments for the vehicle 10 to follow and any potential alternative route segments. For example, the routing module 38 can determine a shortest distance route to the inputted destination from the current location or a shortest time of travel to the inputted destination from the current location and can output one or more series of road segments. The routing module 38 outputs the route information 54 to the motion planning module 40.

The motion planning module 40 receives the localization information 44, the roadmap information 46, the traffic light information 48, the speed limit information 50, the obstacle information 52, and the route information 54 and determines an optimal current trajectory for the vehicle 10 to follow over the predetermined time period, with the trajectory including a selected set of waypoints for the vehicle to follow. As shown in FIG. 3, the localization information 44, the roadmap information 46, the traffic light information 48, the speed limit information 50, the obstacle information 52, and the route information 54 are collectively referred to as inputs 56. As noted above, the motion planning module 40 selects an optimal trajectory from multiple possible trajectories for the vehicle 10 to follow. The motion planning module 40 outputs the selected current trajectory to the control module 42 and the control module 42 controls the vehicle actuation systems 16, i.e., the steering system, the throttle system 20, and the braking system 22, to follow the current selected trajectory with the vehicle 10.

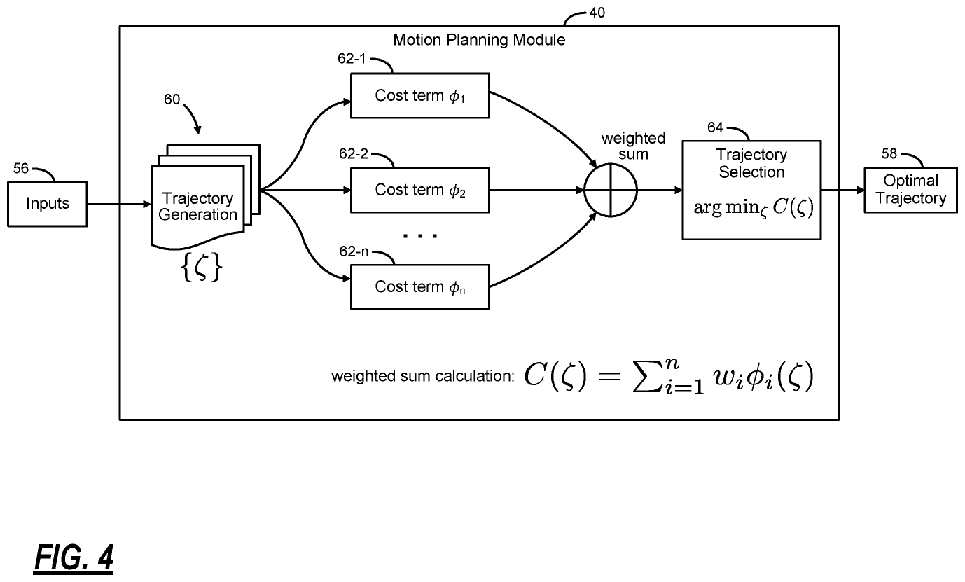

With reference to FIG. 4, a combination block diagram and flow diagram for the motion planning module 40 is shown. As noted above, the motion planning module 40 receives inputs 56 and generates an optimal trajectory 58, which is outputted to the control module 42. Based on the received inputs 56, the motion planning module 40 generates a set of dynamically feasible and smooth trajectories {ζ} that could potentially be traveled by the vehicle 10. Each of the trajectories have, for example, corresponding end points, such as thirty meters ahead in the current lane, thirty meters ahead in the left neighbor lane, thirty meters ahead in the right neighbor lane, etc.

The motion planning module 40 then calculates a total estimated cost for each of the generated trajectories {ζ} by using one or more cost functions or cost terms, illustrated in FIG. 4 as Cost term ϕ₁ 62-1, Cost term ϕ₂ 62-2, Cost term ϕₙ 62-n, etc. Each of the cost functions corresponds to a particular trajectory evaluation feature, i.e., a particular aspect or feature of the trajectory to be evaluated. For example, a first cost function can be used to evaluate the jerkiness of the potential trajectory on the basis of a derivative of acceleration of the trajectory and could be used to minimize jerkiness of travel. For example, such a cost function can be represented by equation one, as follows:

ϕ₁(ζ)=Σⱼ\dot{a}²(tⱼ), Equation 1:

where a represents acceleration and t corresponds to uniformly sampled timestamps along the trajectory ζ.

As another example, another cost function could be used to evaluate the extent to which the trajectory corresponds to travel down the center of the target lane and could be used to minimize travel away from the center of the target lane. For example, such a cost function can be represented by equation two, as follows:

ϕ₂(ζ)=Σⱼd(tⱼ)², Equation 2:

where d represents a distance of the center of the vehicle from the center of the lane and t corresponds to uniformly sampled timestamps along the trajectory ζ.

While the above cost functions are provided as examples, any number of cost functions can appropriately be used, including cost functions to maximize distance, minimize travel time, minimize the number of lane changes, avoid obstacles, etc.

As shown in FIG. 4, the cost functions or terms 62-1, 62-2, 62-n for each trajectory ζ are multiplied by a corresponding designated weight for the cost function, shown as wᵢ and then summed together to arrive at a total weighted sum associated with the particular trajectory ζ. The summation function for generating the total weight sum for each of the trajectories can be represented by equation three, as follows:

C(ζ)=Σᵢ₌₁ⁿ wᵢϕᵢ(ζ), Equation 3:

where wᵢ represents the designated weight for the associated cost function ϕᵢ and n is the total number of possible trajectories.

The motion planning module 40 then performs trajectory selection 64 by selecting the trajectory with the lowest associated cost from the set of trajectories as the optimal trajectory. The optimal trajectory 58 is then output to the control module 42. The function for selecting the trajectory with the lowest associated cost from the set of trajectories can be represented by equation 4, as follows:

ζ*=arg min C(ζ), Equation 4:

where ζ* is the selected trajectory and the arg min function is a function to select the minimum value from a set, in this case being the associates costs of the set of trajectories.

The motion planning module 40 then outputs the optimal trajectory 58 to the control module 42, which appropriately controls the vehicle actuation system 16 so the vehicle 10 follows the selected optimal trajectory.

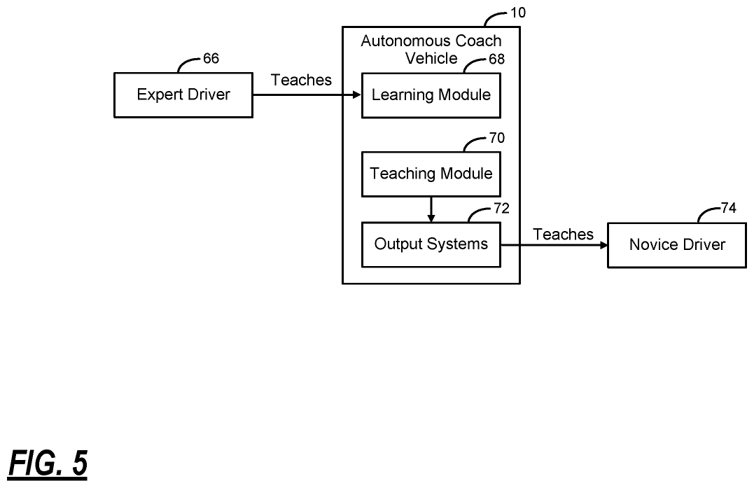

With reference to FIG. 5, a combination block diagram and flow diagram for a system and method of teaching a novice driver with an autonomous coach vehicle is shown. As shown in FIG. 5, the autonomous coach vehicle 10 includes a learning module 68 and a teaching module 70. As noted above, the autonomous coach vehicle 10 of the present teachings can be trained by an expert driver 66. For example, the autonomous coach vehicle 10, prior to training, can include default or initialized values for the cost weights w₁ to wₙ to be used by the motion planning module 40. The autonomous coach vehicle 10 can then be driven in a manual mode by an expert driver 66 while learning module 68 monitors the expert driver's operation and control of the vehicle actuation systems 16, such as the steering system 18, throttle system 20, and braking system 22 of the autonomous coach vehicle 10. The learning module 68 can determine the resulting corresponding actual trajectories traveled by the autonomous coach vehicle 10 based on the operation of the vehicle actuation systems 16 by the expert driver 66. The learning module 68 can also communicate with the motion planning module 40 to determine the calculated trajectories that the vehicle 10 would have selected as the optimal trajectories based on input from the vehicle sensors 12. The learning module 68 can then compare the calculated trajectories with the actual trajectories traveled by the vehicle 10 based on input from the expert driver 66.

Based on the comparison, the learning module 68 can adjust the cost weights w₁ to wₙ used and stored in memory by the motion planning module 40 for selecting the optimal trajectory for the vehicle 10. By adjusting the cost weights w₁ to wₙ, the behavior of the autonomous coach vehicle 10 can more closely mimic the behavior of the vehicle 10 when it is driven by the expert driver 66. In this way, the expert driver 66 can train the autonomous coach vehicle 10. Once trained, the motion planning module 40 of the autonomous coach vehicle 10 will use the updated cost weights w₁ to wₙ and select trajectories that are more similar to the driving of the expert driver 66, as compared with those of the autonomous coach vehicle 10 prior to training.

As discussed in further detail below, the learning module 68 of the autonomous coach vehicle 10 can update the cost weights w₁ to wₙ used by the motion planning module 40 on-line, while the expert driver 66 is driving the autonomous coach vehicle 10. In this way, the learning module 68 performs the comparisons and calculations needed to update the weights cost weights w₁ to wₙ used by the motion planning module 40 periodically, while the expert driver is driving the autonomous coach vehicle 10. For example, the learning module may update the cost weights w₁ to wₙ once every ten seconds. While ten seconds is used as an example time period, any other time period can be used. The learning module 68 can use machine learning and optimization techniques to update the cost weights w₁ to wₙ. For example, the learning module 68 can use the Maximum Margin Planning algorithm described in “Maximum Margin Planning,” Proceedings of the 23^{rd} International Conference on Machine Learning, Ratliff, Nathan D., J. Andrew Bagnell, and Martin A. Zinkevich, A C M, 2006, which is incorporated herein by reference, to update the cost weights w₁ to wₙ.

As discussed in further detail below, once trained, the autonomous coach vehicle 10 can be used to train a novice driver 74, such as a student driver. For example, the novice driver 74 can drive the autonomous coach vehicle 10 in the manual mode while a teaching module 70 of the autonomous coach vehicle 10 monitors the novice driver's operation and control of vehicle actuation systems 16, such as the steering system 18, throttle system 20, and braking system 22. The teaching module 70 can determine the resulting corresponding actual trajectories traveled by autonomous coach vehicle 10 based on the novice driver's operation of the vehicle actuation systems 16. The teaching module 70 can also communicate with the motion planning module 40 to determine the calculated trajectories that the motion planning module 40 would have selected based on input from the vehicle sensors 12 and compare the calculated trajectories with the actual trajectories being driven by autonomous coach vehicle 10 based on the novice driver's operation and control of the vehicle actuation systems 16 of the autonomous coach vehicle 10.

Based on the comparison, the teaching module 70 can provide visual, audio, and/or haptic feedback to the novice driver through the use of visual, audio, and/or haptic output systems 72. For example, when the actual trajectories of the vehicle 10 deviate more than a predetermined amount from the calculated trajectories, the teaching module 70 can control the visual, audio, and/or haptic output systems 72 in the autonomous coach vehicle 10 to provide visual, audio, or haptic feedback to alert the novice driver 74 to make adjustments to the novice driver's driving behavior. For example, if the novice driver 74 is driving the vehicle too close to an edge of the road or too close to another vehicle traveling ahead of the autonomous coach vehicle 10, the teaching module can issue visual, audio, and/or haptic feedback via the output systems 72 to instruct the novice driver 74 to move the vehicle 10 away from the edge of road, to move the vehicle 10 closer to the center of the road, and/or to slow down to allow a greater distance to the vehicle traveling ahead of the autonomous coach vehicle 10. In this way, the teaching module 70 provides feedback and instruction to the novice driver 74 so that the novice driver's driving behavior more closely mimics the driving behavior that would be exhibited if the autonomous coach vehicle 10 were being driving in an autonomous mode and more closely mimics the driving behavior that would be exhibited if the vehicle 10 were being driven by the expert driver 66.

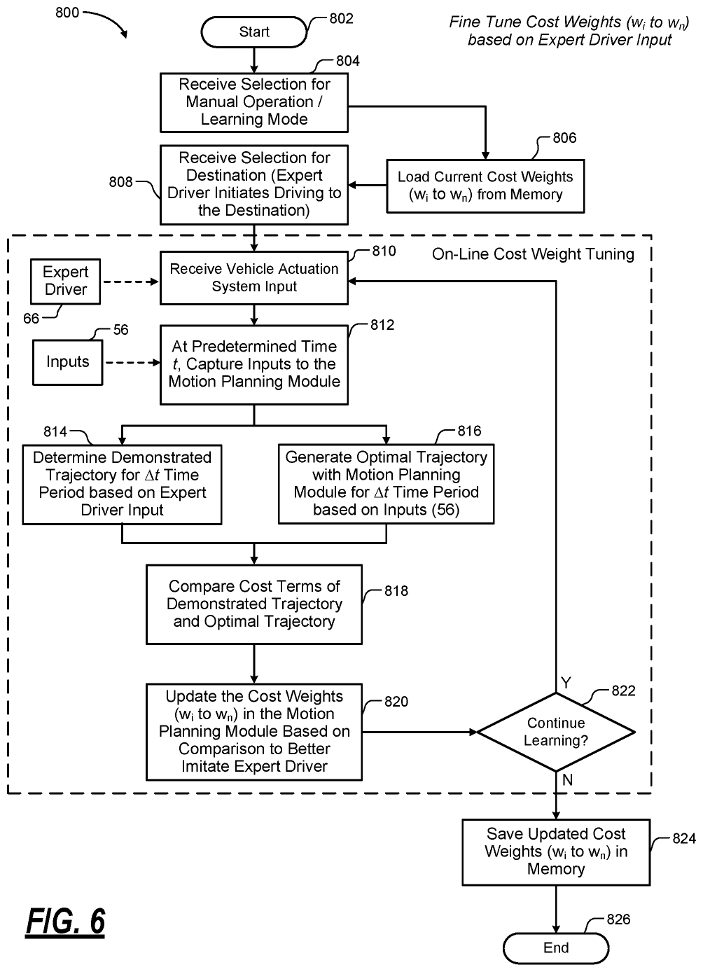

With reference to FIG. 6, a flow diagram for a method 800 of fine tuning cost weights for the autonomous coach vehicle 10 according to the present teachings is shown. The method 800 can be performed by the learning module 68 of the autonomous vehicle 10 in conjunction with the autonomous driving system 14, including the motion planning module 40, and with input from the expert driver 66 and the inputs 56, described above. As discussed above, the method 800 can be performed online while an expert driver is driving the vehicle 10. For example, the method 800 can be performed iteratively, once every predetermined time period, such as once every ten seconds. While ten seconds is provided as an example, any other time period could be used. The method 800 starts at 802.

At 804, the learning module 68 receives a selection for operation of the autonomous coach vehicle 10 in a manual operation/learning mode. At 806, the motion planning module 40 loads the current cost weights w₁ to wₙ from memory. For example, if this is the first time the vehicle is being operated in the manual operating/learning mode, the cost weights w₁ to wₙ will be the initial or default cost weights assigned at the time of manufacture or programming of the autonomous coach vehicle 10. If the autonomous coach vehicle 10 has been previously operated in the manual operation/learning mode, the cost weights w₁ to wₙ will be the cost weights saved at the end of the last training session when the vehicle 10 was operated in the manual operation/learning mode.

At 808, the autonomous coach vehicle 10 receives a selection for a destination for the driving of the autonomous coach vehicle 10 from the expert driver 66. As noted above, the destination can be input to the input system 24 by the expert driver 66 and received by the routing module 38. At 808, once the destination is input, the expert driver 66 can begin to drive the autonomous coach vehicle 10 to the selected destination.

At 810, the on-line cost weight tuning algorithm begins and the vehicle 10 receives vehicle actuation system input from the expert driver 66. In other words, the expert driver 66 operates and drives the vehicle by operating the vehicle actuation systems 16, including the steering system 18, the throttle system 20, and the braking system 22.

At 812, at a predetermined time t, the learning module 68 captures the inputs 56 to the motion planning module 40. At 814, the learning module 68 determines the demonstrated actual trajectory for the time period Δt being driven by the autonomous coach vehicle 10 based on the control of the vehicle actuation system 16 by the expert driver 66. In parallel, at 816, the learning module 68 also determines the optimal trajectory that would have been selected by the motion planning module 40 for the time period Δt based on the received inputs 56.

At 818, the learning module 68 compares the demonstrated actual trajectory, based on the input of the expert driver 66, with the calculated optimal trajectory, as generated by the motion planning module 40. At 820, the learning module 68 updates the cost weights w₁ to wₙ used by the motion planning module 40 based on the comparison so that the motion planning module 40 will, in the future, select an optimal trajectory that more closely mimics the behavior of the expert driver 66 when presented with similar inputs 56. As noted above, the learning module 68 can use machine learning and optimization techniques to update the cost weights w₁ to wₙ. For example, the learning module 68 can use the Maximum Margin Planning algorithm described in “Maximum Margin Planning,” Proceedings of the 23^{rd} International Conference on Machine Learning, Ratliff, Nathan D., J. Andrew Bagnell, and Martin A. Zinkevich, A C M, 2006, which is incorporated herein by reference, to update the cost weights w₁ to wₙ.

At 822, the learning module 68 determines whether to continue learning. For example, the learning module 68 can continue learning while the autonomous coach vehicle 10 is being driven to the destination. Alternatively, the learning module 68 can continue learning until the calculated optimal trajectory is within a predetermined threshold of the demonstrated actual trajectory. Alternatively, the learning module 68 can continue learning until the autonomous coach vehicle is turned off, provided a new destination is input once the previous destination has been reached. Alternatively, the learning module 68 can continue learning until a predetermined time has lapsed since any of the cost weights w₁ to wₙ were last updated.

At 822, when the learning module 68 continues learning, it loops back to 810 and continues to receive vehicle actuation system input from the expert driver 66 and to capture the inputs to the motion planning module 812, etc. At 822, when the learning has ended, the learning module 68 proceeds to 824 and saves the final updated cost weights w₁ to wₙ in the memory to be used by the motion planning module 40. At 826, the method 800 ends.

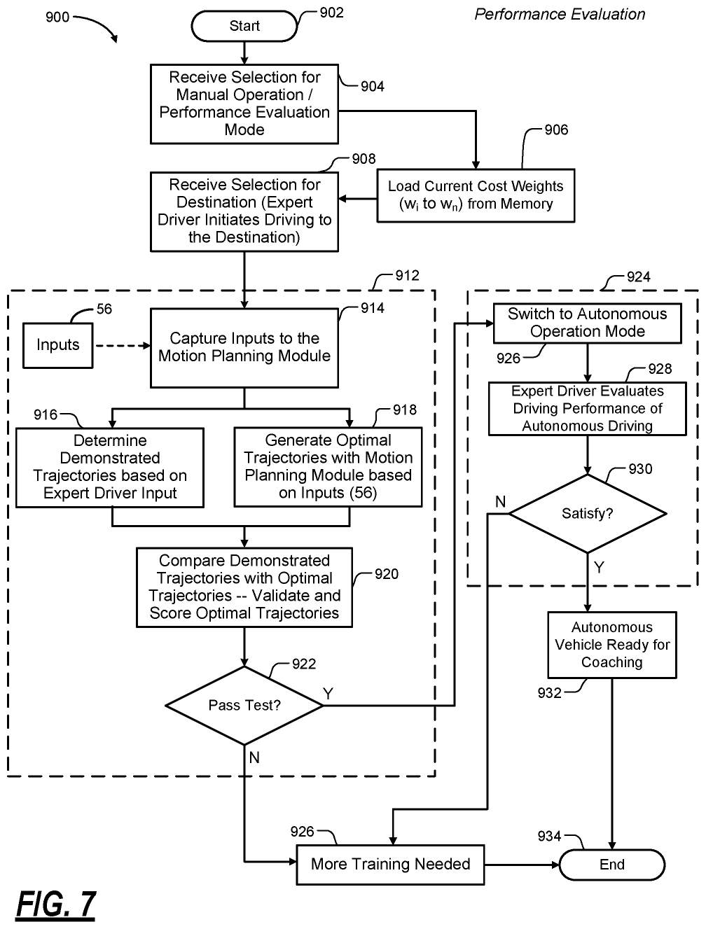

With reference to FIG. 7, a flow diagram for a method 900 of performance evaluation of an autonomous coach vehicle 10 according to the present teachings is shown. The method 900 can be performed by the learning module 68 of the autonomous vehicle 10 in conjunction with the autonomous driving system 14, including the motion planning module 40, and with input from the expert driver 66 and the inputs 56, described above. The method 900 starts at 902.

At 904, the learning module 68 receives a selection for operation of the autonomous coach vehicle 10 in a manual operation/performance evaluation mode. At 906, the motion planning module 68 loads the current cost weights w₁ to wₙ from memory. At 908, the autonomous coach vehicle 10 receives a selection for a destination for the driving of the autonomous coach vehicle 10 from the expert driver 66. As noted above, the destination can be input to the input system 24 by the expert driver 66 and received by the routing module 38. At 908, once the destination is input, the expert driver 66 can begin to drive the autonomous coach vehicle 10 to the selected destination. The learning module 68 then proceeds to a first stage 912 of the performance evaluation method.

At 914, the learning module 68 captures the inputs 56 to the motion planning module 40 over a predetermined time period. At 916, the learning module 68 determines the demonstrated actual trajectories being driven by the autonomous coach vehicle 10 over the predetermined time period based on the control of the vehicle actuation system 16 by the expert driver 66. In parallel, at 918, the learning module 68 also determines the optimal trajectories that would have been selected by the motion planning module 40 for the predetermined time based on the received inputs 56. The predetermined time period in the first stage 912 of the performance evaluation method can be, for example, the time that it takes for the autonomous coach vehicle 10 to travel to the selected destination. For further example, the predetermined time period in the first stage 912 can be a time period such as an hour or thirty minutes, although any time period can be used.

At 920, the learning module 68 compares the actual demonstrated trajectories with the calculated optimal trajectories. Based on the comparison, the learning module 68 validates and scores the optimal trajectories. For example, the learning module 68 can score each of the individual selected optimal trajectories by the motion planning module 40 based on how close the selected optimal trajectory is to the corresponding actual demonstrated trajectory. For example, a theoretical exact match between the selected optimal trajectory and the corresponding actual demonstrated trajectory, although unlikely, could be given the highest possible score, such as one-hundred percent. The individual selected optimal trajectories can be given a score based on how close each is to the corresponding actual demonstrated trajectory. In other words, the learning module 68 can give the selected optimal trajectory a score as a function of how close it was to the corresponding actual demonstrated trajectory. Once all of the selected optimal trajectories have been scored and validated, the learning module 68 proceeds to 922.

At 922, the learning module 68 determines whether selected optimal trajectories by the motion planning module 40 have passed a predetermined test. For example, the learning module 68 may determine that the selected optimal trajectories pass the test when a predetermined number or percentage of the trajectories are have at least a predetermined score. When the selected optimal trajectories have passed the test, the learning module 68 proceeds to the second stage 924 of performance evaluation. When the selected optimal trajectories have not passed the test, the learning module 68 proceeds to 926 and indicates that more training is needed. The additional training, for example, may correspond to the fine tuning of the cost weights discussed above with respect to FIG. 6. The method 900 then ends at 934.

In the second stage 924 of performance evaluation, the learning module 68 proceeds to 926 and switches the vehicle 10 to an autonomous operation mode. In the autonomous operation mode, the vehicle 10 autonomous drives to a selected destination by operating the vehicle actuation systems 16 and without operation of the vehicle actuation systems 16 by the expert driver 66.

At 928, the expert driver 66 evaluates the driving performance of the autonomous driving of the autonomous vehicle 10. At 930, when the expert driver 66 determines that the autonomous driving of the autonomous vehicle 10 is satisfactory, the method 900 proceeds to 932 and the autonomous vehicle 10 is determined to be ready for coaching. For example, the expert driver 66 may input to the input system 24 that the autonomous vehicle 10 has satisfied the second stage 924 of evaluation. The method then ends at 934.

At 930, when the expert driver 66 indicates that the autonomous vehicle 10 has not autonomous driven satisfactorily, the method 900 proceeds to 926 and it is determined that more training is needed. For example, the expert driver 66 may input to the input system 24 that the autonomous vehicle 10 has not satisfied the second stage 924 of evaluation. The additional training, for example, may correspond to the fine tuning of the cost weights discussed above with respect to FIG. 6. The method 900 then ends at 934.

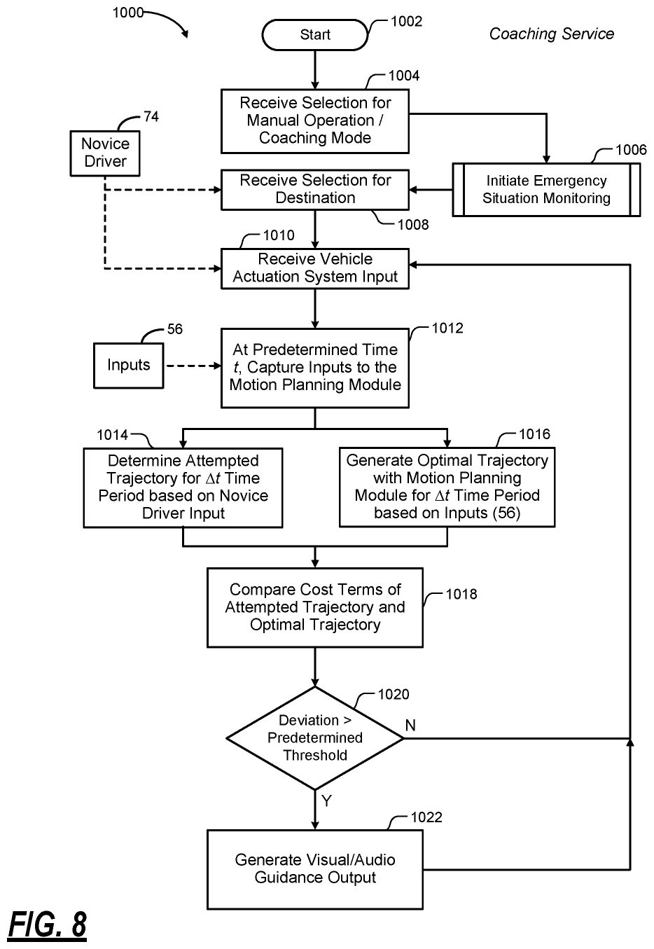

With reference to FIG. 8, a flow diagram for a method 1000 for a coaching service provided by an autonomous coach vehicle 10 according to the present teachings is shown. The method 1000 can be performed by the teaching module 70, shown in FIG. 5, in conjunction with the autonomous driving system 14, including the motion planning module 40, and with input from the novice driver 74 and the inputs 56, described above. The method 1000 starts at 1002.

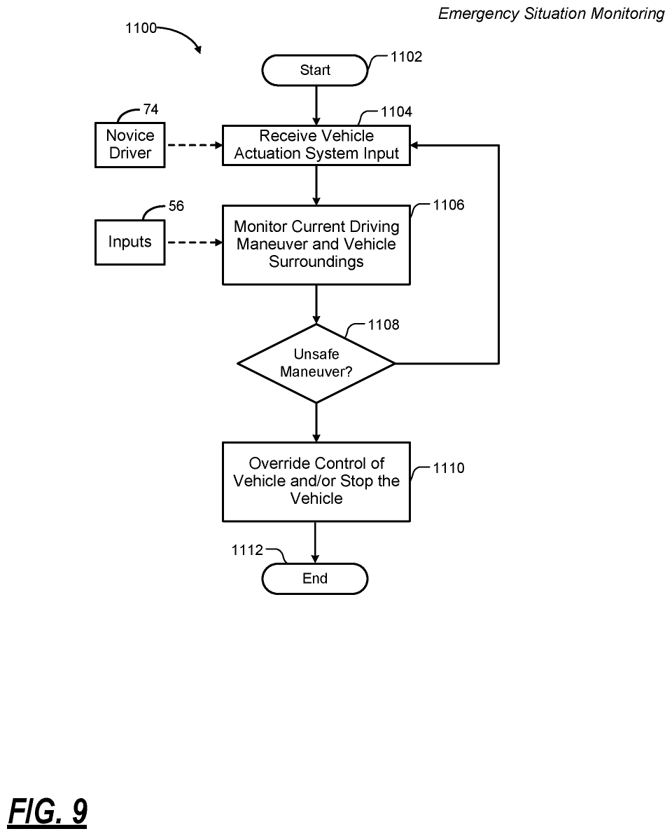

At 1004, the teaching module 70 receives a selection for operation of the autonomous coach vehicle 10 in a manual operation/coaching mode. At 1006, the teaching module 70 initiates an emergency situation monitoring service/procedure, described in further detail below with reference to FIG. 9.

At 1008, the autonomous coach vehicle 10 receives a selection for a destination for the driving of the autonomous coach vehicle 10. The destination can be input to the input system 24, for example, by the novice driver 74. Alternatively, the destination can be input by the expert driver 66. Alternatively, the destination can be preset or predetermined. As noted above, the destination received by the routing module 38. At 1008, once the destination is input, the novice driver 74 can begin to drive the autonomous coach vehicle 10 to the selected destination. At 1010, the vehicle 10 receives vehicle actuation system input from the novice driver 74. In other words, the novice driver 74 operates and drives the vehicle by operating the vehicle actuation system 16, including the steering system 18, the throttle system 20, and the braking system 22. The learning module 68 then proceeds to 1012.

At 1012, at a predetermined time t, the teaching module 70 captures the inputs 56 to the motion planning module 40. At 1014, the teaching module 70 determines the demonstrated attempted trajectory for the time period Δt being driven by the autonomous coach vehicle 10 based on the control of the vehicle actuation system 16 by the novice driver 74. In parallel, at 1016, the teaching module 68 also determines the optimal trajectory that would have been selected by the motion planning module 40 for the time period Δt based on the received inputs 56.

At 1018, the teaching module 70 compares the demonstrated attempted trajectory, based on the input of the novice driver 74, with the calculated optimal trajectory, as generated by the motion planning module 40. At 1020, teaching module 70 determines whether a deviation or difference between the demonstrated attempted trajectory and the calculated optimal trajectory is greater than a predetermined threshold. When the deviation or difference between the demonstrated attempted trajectory and the calculated optimal trajectory is not greater than the predetermined threshold, the teaching module 70 loops back to 1010 and continues to receive additional vehicle actuation system input from the novice driver 74 and to capture inputs 56 to the motion planning module 40 at 1012.

At 1020, when the deviation or difference between the demonstrated attempted trajectory and the calculated optimal trajectory is greater than the predetermined threshold, the teaching module 70 proceeds to 1022 and generates visual, audio, or haptic guidance output with the output systems 72, shown in FIG. 5. For example, the teaching module 70 can control the visual, audio, and/or haptic output systems 72 in the autonomous coach vehicle 10 to provide visual, audio, or haptic feedback to alert the novice driver 74 to make adjustments to the novice driver's driving behavior. For example, if the novice driver 74 is driving the vehicle too close to an edge of the road or too close to another vehicle traveling ahead of the autonomous coach vehicle 10, the teaching module can issue visual, audio, and/or haptic feedback via the output systems 72 to instruct the novice driver 74 to move the vehicle 10 away from the edge of road, to move the vehicle 10 closer to the center of the road, and/or to slow down to allow a greater distance to the vehicle traveling ahead of the autonomous coach vehicle 10. In this way, the teaching module 70 provides feedback and instruction to the novice driver 74 so that the novice driver's driving behavior more closely mimics the driving behavior that would be exhibited if the autonomous coach vehicle 10 were being driving in an autonomous mode and more closely mimics the driving behavior that would be exhibited if the vehicle 10 were being driven by the expert driver 66. In other words, the teaching module 70 can provide guidance output via the output systems 72 to instruct or guide the novice driver 74 to control the vehicle so that the demonstrated attempted trajectory of the vehicle 10 will more closely mimic the calculated optimal trajectory. The teaching module 70 then loops back to 1010 and continues to receive additional vehicle actuation system input from the novice driver 74 and to capture inputs 56 to the motion planning module 40 at 1012.

In this way, the autonomous coach vehicle 10 with the teaching module 70 of the present teachings can effectively and efficiently teach a novice driver 70 to drive the autonomous coach vehicle 10 and provide feedback and guidance to the novice driver so that the novice driver's driving skills improve and the novice driver's operation of the vehicle actuation systems 16 more closely resemble those of the expert driver 66. In this way, the autonomous coach vehicle 10 of the present teachings can beneficially be used for driver's training to teach and coach novice drivers to driver and operate a vehicle 10. The autonomous coach vehicle 10 of the present teachings provides the technical advantages and benefits of being able to teach the novice or student driver how to drive by using the autonomous coach vehicle 10 itself, and without the need for having a driving instructor riding in the passenger seat with the novice or student driver and providing feedback and instruction to the notice or student driver. For example, the novice or student driver could drive the autonomous coach vehicle 10 without a driving instructor present in the vehicle. Alternatively, the driving instructor could be present in the vehicle to monitor the notice or student driver, but may not need to provide as much feedback and instruction as would be the case without using the autonomous coach vehicle 10 of the present teachings. Additionally or alternatively, a driving instructor or expert driver could be located remotely from the autonomous coach vehicle 10 and could remotely monitor the driving of the autonomous coach vehicle 10 by the novice or student driver. For example, the driving instructor or expert driver could monitor a video feed from a camera of the vehicle to view and evaluate the driving of the autonomous coach vehicle 10 by the novice or student driver. The driving instructor or expert driver could also visually monitor the driving of the autonomous coach vehicle 10 by the novice or student driver from outside the autonomous coach vehicle 10, such as from a platform or other location that would allow for the instructor or expert driver to view the autonomous coach vehicle 10 being driven by the notice or student driver.

With reference to FIG. 9, a flow diagram for a method 1100 for an emergency situation monitoring service/procedure provided by an autonomous coach vehicle 10 according to the present teachings is shown. The method 1100 can be performed by the teaching module 70, shown in FIG. 5, in conjunction with the autonomous driving system 14, including the motion planning module 40, and with input from the novice driver 74 and the inputs 56, described above. The method 1100 starts at 1102.

At 1104, the vehicle 10 receives vehicle actuation system input from the novice driver 74. In other words, the novice driver 74 operates and drives the vehicle by operating the vehicle actuation system 16, including the steering system 18, the throttle system 20, and the braking system 22. The learning module 68 then proceeds to 1106.

At 1106, the teaching module 70 monitors the current driving maneuver being performed by the vehicle 10 based on the input by the novice driver 74 to the vehicle actuation systems 16 and based on the inputs 56, including information generated based on sensed data by the vehicle sensors 12.

At 1108, the teaching module 70 determines whether the current maneuver is an unsafe maneuver. For example, the teaching module 70 can determine whether the current maneuver will result in the vehicle 10 colliding with another vehicle or object. As an example, the teaching module 70 can determine whether the novice driver 74 is starting to change lanes into an adjacent lane while another vehicle is already present in the adjacent lane. As another example, the teaching module 70 can determine whether the novice driver 74 is driving the vehicle 10 towards, or drifting into, an oncoming lane of traffic. As another example, the teaching module 70 can determine whether the novice driver 74 is approaching a stopped vehicle, such as a stopped vehicle at an intersection or stoplight, too fast and is not applying the brakes of the braking system 22 quickly enough or with enough force. When the current maneuver is determined not to be an unsafe maneuver at 1108, the teaching module 70 loops back to 1104 and continues to receive vehicle actuation system input to the vehicle actuation systems 16. When the current maneuver is determined to be an unsafe maneuver at 1108, the teaching module 70 proceeds to 1110.

At 1110, the teaching module 70 overrides control of the vehicle by controlling the vehicle actuation system 16 to avoid or mitigate the current unsafe maneuver being performed by the novice driver's control of the vehicle actuation system. For example, at 1110, the teaching module 70 can control the steering system 18, the braking system 22, and/or the throttle system 20 to avoid a collision. For further example, the teaching module 70 can control the steering system 18 to steer the vehicle 10 back into the current lane. For further example, the teaching module 70 can control the braking system 22 to stop short of colliding with an already stopped vehicle at an intersection or stoplight. Additionally or alternatively, the teaching module 70 can control the vehicle actuation systems 16 to stop by safely pulling over to the side of the road.

At 1112, the method 1100 ends. At this point, the autonomous vehicle 10 can simply take over driving of the vehicle 10 in an autonomous driving mode and drive the novice driver 74 back to an originating location. Additionally or alternatively, the autonomous vehicle 10 can wait to be reset, either by an expert driver present in the vehicle or remotely monitoring the autonomous vehicle.

In this way, the autonomous vehicle 10 can monitor the driving behavior of the novice driver 74 and take over control of the vehicle actuation systems 16 to avoid a collision or unsafe situation.

The present teachings provide a system include a motion planning module configured to iteratively determine a plurality of possible trajectories for a vehicle to follow, calculate an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature, and select an optimal trajectory from the plurality of possible trajectories for each of a plurality of time periods, the optimal trajectory having a least associated estimated cost out of the plurality of possible trajectories. The system also includes a learning module configured to, when the vehicle is operated in a learning mode during a first time period of the plurality of time periods, determine a first actual trajectory being traveled by the vehicle during the first time period, compare the first actual trajectory with the optimal trajectory selected by the motion planning module during the first time period, and update the plurality of cost weights based on the comparison. The system also includes a teaching module configured to, when the vehicle is operated in a teaching mode during a second time period of the plurality of time periods, determine a second actual trajectory being traveled by the vehicle during the second time period, compare the second actual trajectory with the optimal trajectory selected by the motion planning module during the second time period, and generate output to a user of the vehicle based on the comparison.

In one aspect of the present teachings, the generated output provides instructions to the user indicating at least one action for the user to perform to control the vehicle during a third time period of the plurality of time periods so a third actual trajectory traveled by the vehicle during the third time period will correspond to the optimal trajectory selected by the motion planning module during the third time period.

In one aspect of the present teachings, the generated output includes at least one of audio, visual, and haptic output providing instructions for the user to control the vehicle.

In one aspect of the present teachings, the teaching module is further configured to determine a difference between the second actual trajectory and the optimal trajectory selected by the motion planning module during the second time period and to generate the output in response to the difference being greater than a predetermined threshold.

In one aspect of the present teachings, the learning module, when operated in a performance evaluation mode during a third time period of the plurality of time periods, is further configured to determine a third actual trajectory being traveled by the vehicle during the third time period, compare the third actual trajectory with the optimal trajectory selected by the motion planning module during the third time period, and generate a score for the optimal trajectory selected by the motion planning module during the third time period, the score representing how closely the optimal trajectory selected by the motion planning module during the third time period matches the third actual trajectory, and wherein the learning module determines whether additional operation of the vehicle in the learning mode is needed based at least in part on the score.

In one aspect of the present teachings, the teaching module is further configured to, when the vehicle is operated in the teaching mode during the second time period of the plurality of time periods, perform at least one of overriding control of the vehicle and stopping the vehicle in response to determining that the second actual trajectory corresponds to an unsafe maneuver of the vehicle by the user.

In one aspect of the present teachings, the system also includes at least one vehicle sensor includes at least one of a vehicle speed sensor, a vehicle acceleration sensor, an image sensor, a Lidar sensor, a radar sensor, a stereo sensor, an ultrasonic sensor, a global positioning system, and an inertial measurement unit. The system also includes a perception module configured to generate object information about objects in a surrounding environment of the vehicle based on data from the at least one vehicle sensor. The system also includes a prediction module configured to generate obstacle information based on the object information from the perception module. In one aspect of the present teachings, the motion planning module is configured to determine the plurality of possible trajectories for the vehicle to follow based on the obstacle information from the prediction module and the object information from the perception module.

In one aspect of the present teachings, the system also includes a control module configured to, when the vehicle is operated in an autonomous driving mode, control actuation systems of the vehicle to drive the vehicle according to the selected optimal trajectory, the actuation systems including at least one of a steering system, a throttle system, and a braking system.

The present teachings also includes a method that includes determining, with a motion planning module, a plurality of possible trajectories for a vehicle to follow, and calculating, with the motion planning module, an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature. The method also includes selecting, with the motion planning module, an optimal trajectory from the plurality of possible trajectories for each of a plurality of time periods, the optimal trajectory having a least associated estimated cost out of the plurality of possible trajectories. The method also includes determining, with a learning module and when the vehicle is operated in a learning mode during a first time period of the plurality of time periods, a first actual trajectory being traveled by the vehicle during the first time period. The method also includes comparing, with the learning module, the first actual trajectory with the optimal trajectory selected by the motion planning module during the first time period. The method also includes updating, with the learning module, the plurality of cost weights based on the comparison. The method also includes determining, with a teaching module and when the vehicle is operated in a teaching mode during a second time period of the plurality of time periods, a second actual trajectory being traveled by the vehicle during the second time period. The method also includes comparing, with the teaching module, the second actual trajectory with the optimal trajectory selected by the motion planning module during the second time period. The method also includes generating, with the teaching module, output to a user of the vehicle based on the comparison.

In one aspect of the present teachings, the generated output provides instructions to the user indicating at least one action for the user to perform to control the vehicle during a third time period of the plurality of time periods so a third actual trajectory traveled by the vehicle during the third time period will correspond to the optimal trajectory selected by the motion planning module during the third time period.

In one aspect of the present teachings, the generated output includes at least one of audio, visual, and haptic output providing instructions for the user to control the vehicle.

In one aspect of the present teachings, the method includes determining, with the teaching module, a difference between the second actual trajectory and the optimal trajectory selected by the motion planning module during the second time period, and generating, with the teaching module, the output in response to the difference being greater than a predetermined threshold.

In one aspect of the present teachings, the method includes determining, with the learning module and when the vehicle is operated in a performance evaluation mode during a third time period of the plurality of time periods, a third actual trajectory being traveled by the vehicle during the third time period. The method also includes comparing, with the learning module, the third actual trajectory with the optimal trajectory selected by the motion planning module during the third time period. The method also includes generating, with the learning module, a score for the optimal trajectory selected by the motion planning module during the third time period, the score representing how closely the optimal trajectory selected by the motion planning module during the third time period matches the third actual trajectory. The method also includes determining, with the learning module, whether additional operation of the vehicle in the learning mode is needed based at least in part on the score.

In one aspect of the present teachings, the method also includes performing, with the teaching module and when the vehicle is operated in the teaching mode during the second time period of the plurality of time periods, at least one of overriding control of the vehicle and stopping the vehicle in response to determining that the second actual trajectory corresponds to an unsafe maneuver of the vehicle by the user.

In one aspect of the present teachings, the method also includes generating, with a perception module, object information about objects in a surrounding environment of the vehicle based on data from at least one vehicle sensor including at least one of a vehicle speed sensor, a vehicle acceleration sensor, an image sensor, a Lidar sensor, a radar sensor, a stereo sensor, an ultrasonic sensor, a global positioning system, and an inertial measurement unit. The method also includes generating, with a prediction module, obstacle information based on the object information from the perception module. The method also includes determining, with the motion planning module, the plurality of possible trajectories for the vehicle to follow based on the obstacle information from the prediction module and the object information from the perception module.

In one aspect of the present teachings, the method further includes controlling, with a control module and when the vehicle is operated in an autonomous driving mode, actuation systems of the vehicle to drive the vehicle according to the selected optimal trajectory, the actuation systems including at least one of a steering system, a throttle system, and a braking system.

The present teachings include an autonomous coach vehicle comprising at least one vehicle sensor including at least one of a vehicle speed sensor, a vehicle acceleration sensor, an image sensor, a Lidar sensor, a radar sensor, a stereo sensor, an ultrasonic sensor, a global positioning system, and an inertial measurement unit. The autonomous coach vehicle further includes a perception module configured to generate object information about objects in a surrounding environment of the autonomous coach vehicle based on data from the at least one vehicle sensor. The autonomous coach vehicle further includes a prediction module configured to generate obstacle information based on the object information from the perception module. The autonomous coach vehicle further includes a motion planning module configured to iteratively determine a plurality of possible trajectories for the autonomous coach vehicle to follow based on the object information from the perception module and the obstacle information from the prediction module, calculate an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature, and select an optimal trajectory from the plurality of possible trajectories for each of a plurality of time periods, the optimal trajectory having a least associated estimated cost out of the plurality of possible trajectories. The autonomous coach vehicle further includes a learning module configured to, when the autonomous coach vehicle is operated in a learning mode during a first time period of the plurality of time periods, determine a first actual trajectory being traveled by the autonomous coach vehicle during the first time period, compare the first actual trajectory with the optimal trajectory selected by the motion planning module during the first time period, and update the plurality of cost weights based on the comparison. The autonomous coach vehicle further includes a teaching module configured to, when the autonomous coach vehicle is operated in a teaching mode during a second time period of the plurality of time periods, determine a second actual trajectory being traveled by the autonomous coach vehicle during the second time period, compare the second actual trajectory with the optimal trajectory selected by the motion planning module during the second time period, and generate output to a user of the autonomous coach vehicle when a difference between the second actual trajectory and the optimal trajectory is greater than a predetermined threshold, the generated output providing instructions to the user indicating at least one action for the user to perform to control the autonomous coach vehicle during a third time period of the plurality of time periods so a third actual trajectory traveled by the autonomous coach vehicle during the third time period will correspond to the optimal trajectory selected by the motion planning module during the third time period.

In one aspect of the present teachings, the generated output includes at least one of audio, visual, and haptic output.

In one aspect of the present teachings, the teaching module is further configured to, when the autonomous coach vehicle is operated in the teaching mode during the second time period of the plurality of time periods, determine whether the second actual trajectory corresponds to an unsafe maneuver of the autonomous coach vehicle by the user and perform at least one of overriding control of the autonomous coach vehicle and stopping the autonomous coach vehicle in response to determining that the second actual trajectory corresponds to the unsafe maneuver of the autonomous coach vehicle by the user.

In one aspect of the present teachings, the autonomous coach vehicle further includes a control module configured to, when the autonomous coach vehicle is operated in an autonomous driving mode, control actuation systems of the autonomous coach vehicle to drive the autonomous coach vehicle according to the selected optimal trajectory, the actuation systems including at least one of a steering system, a throttle system, and a braking system.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A and B should be construed to mean a logical (A OR B), using a non-exclusive logical OR. For example, the phrase at least one of A and B should be construed to include any one of: (i) A alone; (ii) B alone; (iii) both A and B together. The phrase at least one of A and B should not be construed to mean “at least one of A and at least one of B.” The phrase at least one of A and B should also not be construed to mean “A alone, B alone, but not both A and B together.” The term “subset” does not necessarily require a proper subset. In other words, a first subset of a first set may be coextensive with, and equal to, the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
a motion planning module configured to iteratively determine a plurality of possible trajectories for a vehicle to follow, calculate an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature, and select an optimal trajectory from the plurality of possible trajectories for each of a plurality of time periods, the optimal trajectory having a least associated estimated cost out of the plurality of possible trajectories;
a learning module configured to, when the vehicle is operated in a learning mode during a first time period of the plurality of time periods, determine a first actual trajectory being traveled by the vehicle during the first time period, compare the first actual trajectory with the optimal trajectory selected by the motion planning module during the first time period, and update the plurality of cost weights based on the comparison; and
a teaching module configured to, when the vehicle is operated in a teaching mode during a second time period of the plurality of time periods, determine a second actual trajectory being traveled by the vehicle during the second time period, compare the second actual trajectory with the optimal trajectory selected by the motion planning module during the second time period, and generate output to a user of the vehicle based on the comparison.

2. The system recited by claim 1, wherein the generated output provides instructions to the user indicating at least one action for the user to perform to control the vehicle during a third time period of the plurality of time periods so a third actual trajectory traveled by the vehicle during the third time period will correspond to the optimal trajectory selected by the motion planning module during the third time period.

3. The system recited by claim 1, wherein the generated output includes at least one of audio, visual, and haptic output providing instructions for the user to control the vehicle.

4. The system recited by claim 1, wherein the teaching module is further configured to determine a difference between the second actual trajectory and the optimal trajectory selected by the motion planning module during the second time period and to generate the output in response to the difference being greater than a predetermined threshold.

5. The system recited by claim 1, wherein the learning module, when operated in a performance evaluation mode during a third time period of the plurality of time periods, is further configured to determine a third actual trajectory being traveled by the vehicle during the third time period, compare the third actual trajectory with the optimal trajectory selected by the motion planning module during the third time period, and generate a score for the optimal trajectory selected by the motion planning module during the third time period, the score representing how closely the optimal trajectory selected by the motion planning module during the third time period matches the third actual trajectory, and wherein the learning module determines whether additional operation of the vehicle in the learning mode is needed based at least in part on the score.

6. The system recited by claim 1, wherein the teaching module is further configured to, when the vehicle is operated in the teaching mode during the second time period of the plurality of time periods, perform at least one of overriding control of the vehicle and stopping the vehicle in response to determining that the second actual trajectory corresponds to an unsafe maneuver of the vehicle by the user.

7. The system recited by claim 1, further comprising:
at least one vehicle sensor including at least one of a vehicle speed sensor, a vehicle acceleration sensor, an image sensor, a Lidar sensor, a radar sensor, a stereo sensor, an ultrasonic sensor, a global positioning system, and an inertial measurement unit;
a perception module configured to generate object information about objects in a surrounding environment of the vehicle based on data from the at least one vehicle sensor; and
a prediction module configured to generate obstacle information based on the object information from the perception module;
wherein the motion planning module is configured to determine the plurality of possible trajectories for the vehicle to follow based on the obstacle information from the prediction module and the object information from the perception module.

8. The system recited by claim 1, further comprising a control module configured to, when the vehicle is operated in an autonomous driving mode, control actuation systems of the vehicle to drive the vehicle according to the selected optimal trajectory, the actuation systems including at least one of a steering system, a throttle system, and a braking system.

9. A method comprising:
determining, with a motion planning module, a plurality of possible trajectories for a vehicle to follow;
calculating, with the motion planning module, an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature;
selecting, with the motion planning module, an optimal trajectory from the plurality of possible trajectories for each of a plurality of time periods, the optimal trajectory having a least associated estimated cost out of the plurality of possible trajectories;
determining, with a learning module and when the vehicle is operated in a learning mode during a first time period of the plurality of time periods, a first actual trajectory being traveled by the vehicle during the first time period;
comparing, with the learning module, the first actual trajectory with the optimal trajectory selected by the motion planning module during the first time period;
updating, with the learning module, the plurality of cost weights based on the comparison;
determining, with a teaching module and when the vehicle is operated in a teaching mode during a second time period of the plurality of time periods, a second actual trajectory being traveled by the vehicle during the second time period;
comparing, with the teaching module, the second actual trajectory with the optimal trajectory selected by the motion planning module during the second time period; and
generating, with the teaching module, output to a user of the vehicle based on the comparison.

10. The method recited by claim 9, wherein the generated output provides instructions to the user indicating at least one action for the user to perform to control the vehicle during a third time period of the plurality of time periods so a third actual trajectory traveled by the vehicle during the third time period will correspond to the optimal trajectory selected by the motion planning module during the third time period.

11. The method recited by claim 9, wherein the generated output includes at least one of audio, visual, and haptic output providing instructions for the user to control the vehicle.

12. The method recited by claim 9, further comprising:
determining, with the teaching module, a difference between the second actual trajectory and the optimal trajectory selected by the motion planning module during the second time period; and
generating, with the teaching module, the output in response to the difference being greater than a predetermined threshold.

13. The method recited by claim 9, further comprising:
determining, with the learning module and when the vehicle is operated in a performance evaluation mode during a third time period of the plurality of time periods, a third actual trajectory being traveled by the vehicle during the third time period;
comparing, with the learning module, the third actual trajectory with the optimal trajectory selected by the motion planning module during the third time period;
generating, with the learning module, a score for the optimal trajectory selected by the motion planning module during the third time period, the score representing how closely the optimal trajectory selected by the motion planning module during the third time period matches the third actual trajectory; and
determining, with the learning module, whether additional operation of the vehicle in the learning mode is needed based at least in part on the score.

14. The method recited by claim 9, further comprising performing, with the teaching module and when the vehicle is operated in the teaching mode during the second time period of the plurality of time periods, at least one of overriding control of the vehicle and stopping the vehicle in response to determining that the second actual trajectory corresponds to an unsafe maneuver of the vehicle by the user.

15. The method recited by claim 9, further comprising:
generating, with a perception module, object information about objects in a surrounding environment of the vehicle based on data from at least one vehicle sensor including at least one of a vehicle speed sensor, a vehicle acceleration sensor, an image sensor, a Lidar sensor, a radar sensor, a stereo sensor, an ultrasonic sensor, a global positioning system, and an inertial measurement unit;
generating, with a prediction module, obstacle information based on the object information from the perception module; and
determining, with the motion planning module, the plurality of possible trajectories for the vehicle to follow based on the obstacle information from the prediction module and the object information from the perception module.

16. The method recited by claim 9, further comprising controlling, with a control module and when the vehicle is operated in an autonomous driving mode, actuation systems of the vehicle to drive the vehicle according to the selected optimal trajectory, the actuation systems including at least one of a steering system, a throttle system, and a braking system.

17. An autonomous coach vehicle comprising:
at least one vehicle sensor including at least one of a vehicle speed sensor, a vehicle acceleration sensor, an image sensor, a Lidar sensor, a radar sensor, a stereo sensor, an ultrasonic sensor, a global positioning system, and an inertial measurement unit;
a perception module configured to generate object information about objects in a surrounding environment of the autonomous coach vehicle based on data from the at least one vehicle sensor;
a prediction module configured to generate obstacle information based on the object information from the perception module;
a motion planning module configured to iteratively determine a plurality of possible trajectories for the autonomous coach vehicle to follow based on the object information from the perception module and the obstacle information from the prediction module, calculate an estimated cost associated with each possible trajectory of the plurality of possible trajectories based on a plurality of cost functions and a plurality of cost weights, each cost function of the plurality of cost functions having an associated cost weight from the plurality of cost weights and each cost function corresponding to a trajectory evaluation feature, and select an optimal trajectory from the plurality of possible trajectories for each of a plurality of time periods, the optimal trajectory having a least associated estimated cost out of the plurality of possible trajectories;
a learning module configured to, when the autonomous coach vehicle is operated in a learning mode during a first time period of the plurality of time periods, determine a first actual trajectory being traveled by the autonomous coach vehicle during the first time period, compare the first actual trajectory with the optimal trajectory selected by the motion planning module during the first time period, and update the plurality of cost weights based on the comparison; and
a teaching module configured to, when the autonomous coach vehicle is operated in a teaching mode during a second time period of the plurality of time periods, determine a second actual trajectory being traveled by the autonomous coach vehicle during the second time period, compare the second actual trajectory with the optimal trajectory selected by the motion planning module during the second time period, and generate output to a user of the autonomous coach vehicle when a difference between the second actual trajectory and the optimal trajectory is greater than a predetermined threshold, the generated output providing instructions to the user indicating at least one action for the user to perform to control the autonomous coach vehicle during a third time period of the plurality of time periods so a third actual trajectory traveled by the autonomous coach vehicle during the third time period will correspond to the optimal trajectory selected by the motion planning module during the third time period.

18. The autonomous coach vehicle recited by claim 17, wherein the generated output includes at least one of audio, visual, and haptic output.

19. The autonomous coach vehicle recited by claim 17, wherein the teaching module is further configured to, when the autonomous coach vehicle is operated in the teaching mode during the second time period of the plurality of time periods, determine whether the second actual trajectory corresponds to an unsafe maneuver of the autonomous coach vehicle by the user and perform at least one of overriding control of the autonomous coach vehicle and stopping the autonomous coach vehicle in response to determining that the second actual trajectory corresponds to the unsafe maneuver of the autonomous coach vehicle by the user.

20. The autonomous coach vehicle recited by claim 17, further comprising a control module configured to, when the autonomous coach vehicle is operated in an autonomous driving mode, control actuation systems of the autonomous coach vehicle to drive the autonomous coach vehicle according to the selected optimal trajectory, the actuation systems including at least one of a steering system, a throttle system, and a braking system.
